(19) United States
(12) Patent Application Publication
(10) Pub. No.: US 2009/0038014 A1
(43) Pub. Date: Feb. 5, 2009

(54) System and method for tracking remediation of security vulnerabilities

(76) Inventors: Paul Force, Morton, IL (US); Lawrence Edwards, Washington, IL (US); Julianne Davies Martin, Dunlap, IL (US); Steven Cox, East Peoria, IL (US); Anthony Crumb, Canton, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(21) Appl. No.: 11/888,088

(22) Filed: Jul. 31, 2007

(51) Int. Cl. G06F 21/00

(52) U.S. Cl. 726/25

(57) ABSTRACT

A method of tracking remediation of security vulnerabilities includes a step of providing a global list of network devices within a computer network, wherein each network device of the global list is identified with dynamically assigned identifying information. The method also includes a step of scanning each network device of the global list for at least one security vulnerability. The method also includes a step of creating a vulnerability list of network devices having the at least one security vulnerability, wherein the vulnerability list is a subset of the global list and contains fewer network devices than the global list. Each network device of the vulnerability list is identified with identifying information. The method also includes steps of updating the dynamically assigned identifying information associated with the network devices of the vulnerability list and rescanning each network device of the updated vulnerability list to determine if the vulnerability has been remediated.

### TECHNICAL FIELD

The present disclosure relates generally to tracking remediation of security vulnerabilities within a computer network, and more particularly to rescanning network devices having security vulnerabilities until the vulnerabilities are remediated.

### BACKGROUND

Modern computer networks interconnect numerous devices and span regional, national, or even global areas. Communication between the interconnected devices of these networks is facilitated through the use of communication protocols. These protocols are well known and provide means to transfer and share data that may be confidential throughout the entire network. The dependence of organizations and individuals on the confidential data that is communicated using the networks has increased, leading to a heightened awareness of the need to protect data that is communicated though the network and data that is stored by the one or more interconnected devices of the network.

Security vulnerability software is commercially available and provides a common means for assessing the exposure of the interconnected devices of the network. By identifying potential security weaknesses in a network device, the security vulnerability software provides an opportunity to address network vulnerabilities before they are exploited. However, due to the size of most modern networks, a scan of all interconnected devices of a network by the security vulnerability software often takes days, or even weeks, to complete.

A method of limiting vulnerability analysis to only those devices that pose significant security risks is described in U.S. Pat. No. 6,205,552. Specifically, nonresponsive addresses and addresses representing nonshareable devices are filtered from a list of all network addresses assigned for use by the system. The remaining addresses, representing only those shareable devices in use by the system, are then scanned for network security vulnerabilities. Although this method provides a more efficient means of scanning a system for vulnerabilities, it does not even contemplate a timely and efficient method for tracking remediation of the identified vulnerabilities.

The present disclosure is directed to one or more of the problems set forth above.

### SUMMARY OF THE DISCLOSURE

In one aspect, a method of tracking remediation of security vulnerabilities includes a step of providing a global list of network devices within a computer network, wherein each network device of the global list is identified with dynamically assigned identifying information. The method also includes a step of scanning each network device of the global list for at least one security vulnerability. The method also includes a step of creating a vulnerability list of network devices having the at least one security vulnerability, wherein the vulnerability list is a subset of the global list and contains fewer network devices than the global list. Each network device of the vulnerability list is identified with identifying information. The method also includes steps of updating the dynamically assigned identifying information associated with the network devices of the vulnerability list and rescanning each network device of the updated vulnerability list to determine if the vulnerability has been remediated.

In another aspect, a system for tracking remediation of security vulnerabilities includes a computer network with a plurality of devices. A global list of the network devices is provided, wherein each network device of the global list is identified with identifying information. A security vulnerability process is configured to scan each network device of the global list for at least one security vulnerability. A tracking process is configured to create a vulnerability list of network devices having the at least one security vulnerability, and update the dynamically assigned identifying information associated with the network devices of the vulnerability list. The vulnerability list is a subset of the global list and contains fewer network devices than the global list. The security vulnerability process is further configured to rescan each network device of the updated vulnerability list to determine if the vulnerability has been remediated.

### BRIEF DESCRIPTION OF THE DRAWINGS

FIG. 1 is a block diagram of a system including a computer network 12 according to the present disclosure; and

FIG. 2 is a flow chart of one embodiment of a method of tracking remediation of security vulnerabilities of the system of FIG. 1.

### DETAILED DESCRIPTION

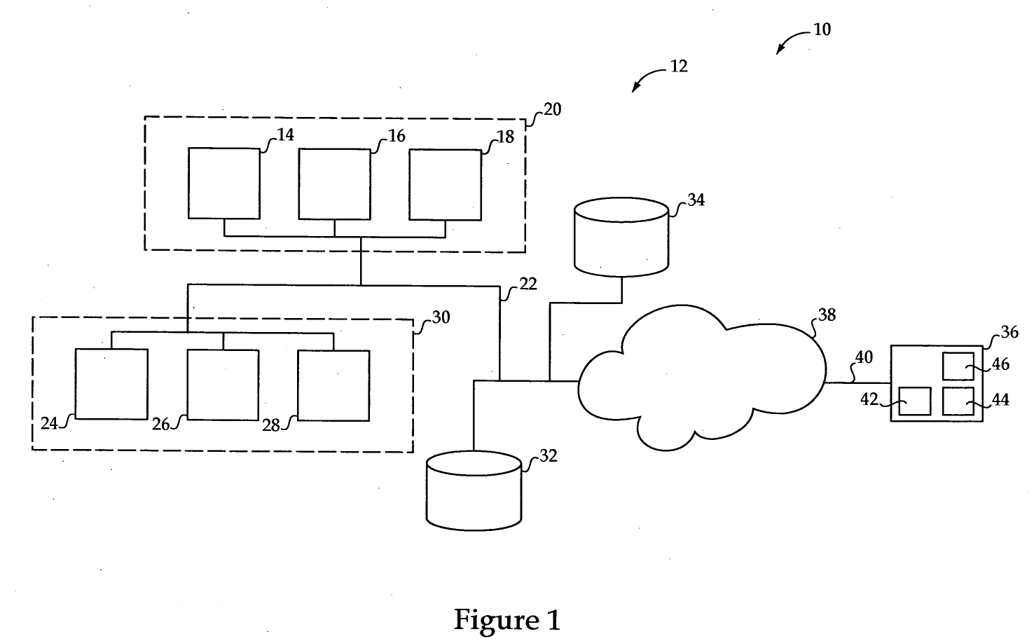

An exemplary embodiment of a system 10 is shown generally in FIG. 1. The system 10 includes a computer network 12 used to facilitate wired and/or wireless communication among a plurality of devices via TCP/IP, NetBEUI, HTTP, or any other known communication protocol. The network 12 may be of any variety of computer networks, such as, for example, a corporate network or a home networking environment, and may comprise a local area network or a wide area network that connects multiple sites.

The computer network 12 may include network devices 14, 16, and 18 at a first location 20 that communicate via a communication line 22. Additional network devices, such as devices 24, 26, and 28, may comprise a second location 30 and may also communicate via the communication line 22. It should be appreciated that each of the first and second locations 20 and 30 may include a subnetwork representing network devices at one geographic location, in one building, or on the same local area network. Alternatively, first and second locations 20 and 30 may represent logical groupings of network devices at the same physical location.

The network devices 14, 16, 18, 24, 26, and 28 may include any common network devices, such as, for example, computers having processors and memories, printers, scanners, facsimile machines, servers, and the like. Computer network 12 may also include a first database, such as a subnetwork database 32, and a second database, such as a contact database 34, connected to the computer network 12 via communication line 22. Although specific examples are given, it should be appreciated that the computer network 12, and first and second locations 20 and 30, may include any addressable devices, systems, routers, gateways, subnetworks, etc.

Each of the network devices 14, 16, 18, 24, 26, and 28, and any other participating network devices, may be dynamically assigned a network address that it uses to identify and communicate with various other devices of the computer network 12 and any outside devices or networks. An exemplary network address includes an Internet protocol (IP) address for networks utilizing the IP communication protocol. Typically, one of the network devices 14, 16, 18, 24, 26, and 28 broadcasts a request to a service provider of the computer network 12 for a network address. A unique network address is, in turn, assigned, and the network device 14, 16, 18, 24, 26, or 28 configures itself to use that network address. If, however, the network device 14, 16, 18, 24, 26, and 28 is not continuously connected to the computer network 12, the network address will be surrendered and may be reused by other network devices. Therefore, during the course of a day, several of the network devices 14, 16, 18, 24, 26, and 28 may have utilized the same dynamically assigned network address.

The subnetwork database 32 may include information that maps each location of computer network 12 to a range of network addresses that may be dynamically assigned to the network devices of that location. For example, first location 20 may be referenced by an identifier, such as “FIRST_LOCATION,” and may be mapped to a range of network addresses that have been allocated for use by first location 20, such as IP addresses 192.168.0.1-192.168.0.20. Similarly, second location 30 may be identified as “SECOND_LOCATION,” and may be mapped to a range of IP addresses, such as IP addresses 192.168.0.21-192.168.0.40. Using subnetwork database 32 as a reference, it can be determined that a network device using IP address 192.168.0.14 belongs to “FIRST_LOCATION” or, more specifically, first location 20.

The contact database 34 may include information that maps a designated contact person to each location of computer network 12. For example, “John Smith” may be mapped to “FIRST_LOCATION,” wherein John Smith is the person to contact regarding first location 20 and/or any of the network devices 14, 16, and 18 of first location 20. Similarly, “Mary Jones” may be mapped to “SECOND_LOCATION,” wherein Mary Jones is the contact person for second location 30 and/or any of the network devices 24, 26, and 28 of second location 30. It should be appreciated that the designated contact information may, alternatively, be stored in subnetwork database 32, or any other data repository. It should also be appreciated that subnetwork database 32 and contact database 34 may include any data model for organizing data and may utilize any database management software, as is well known in the art.

The computer network 12 also includes a security vulnerability tool, or process, 36 for detecting security vulnerabilities within the computer network 12. The security vulnerability tool 36 may include software executed on a server, workstation, or other device and may be configured to scan network devices 14, 16, 18, 24, 26, and 28 of the computer network 12 for security vulnerabilities. Security vulnerabilities typically include product flaws, viruses, incorrectly configured systems, or any other means by which attackers may gain ungranted access to the computer network 12.

Security vulnerability tool 36 may be disposed along the computer network 12 or, alternatively, may connect to the computer network 12 via another network, such as, for example, the Internet 38. The security vulnerability tool 36 may connect to the Internet 38 via a wired and/or wireless connection, such as communication line 40. It should be appreciated that the computer network 12 and the security vulnerability tool 36 may utilize additional devices, such as, for example, firewalls and routers, to protect communication to and from the Internet 38.

More specifically, the security vulnerability tool 36 may scan all network devices of a global list 42 for security vulnerabilities. The global list 42 may include identifying information, such as dynamically assigned identifying information, regarding each network device 14, 16, 18, 24, 26, and 28 of the computer network 12. Alternatively, the global list 42 may include all of the ranges of network addresses that may be dynamically assigned to the network devices 14, 16, 18, 24, 26, and 28 of first location 20 and second location 30. For example, the global list 42 may be synchronized with the information stored in subnetwork database 32. The identifying information associated with each network device of the global list 42, therefore, may include the dynamically assigned network addresses, and any other identifying information. The security vulnerability tool 36, by design, scans each of the network addresses of the global list 42 and identifies the network devices having at least one security vulnerability.

The security vulnerability tool 36 may include QualysGuard® software provided by Qualys, Inc. of Redwood Shores, Calif. Alternatively, the security vulnerability software may include SecurityExpressions® software offered by Altiris, Inc., GFI LANguard® Network Security Scanner from GFI Software, FusionVM® software provided by Critical Watch, Retina® Network Security Scanner from eEye Digital Security®, SAINT® Network Vulnerability Scanner offered by SAINT® Corporation, STAT® Guardian Vulnerability Management Suite from Harris® Corporation, or any other known security vulnerability tool.

The scan of the security vulnerability tool 36 may identify network devices having security vulnerabilities with identifying information. Such identifying information may include a network address, such as a dynamically assigned IP address. Additionally, the identifying information may include a Domain Name Server (DNS) name, if detected, and/or a Network Basic Input Output System (NetBIOS) host name, if detected, or any other directory names or host names that are associated with the network address. It should be appreciated that the security vulnerability tool 36 may be configured to return any desired information regarding network devices identified as having security vulnerabilities.

A tracking process 44 may be executed on the same server, workstation, or other device as the security vulnerability tool 36 and may create a vulnerability list 46 including all of the network devices identified by the security vulnerability tool 36 as having security vulnerabilities. The network devices of the vulnerability list 46 may be identified with the identifying information returned by the security vulnerability tool 36. Further, the tracking process 44 may access the subnetwork database 32 to determine the location associated with each of the network devices of the vulnerability list 46. Alternatively, the security vulnerability tool 36 may be configured to store and/or track this location information. The vulnerability list 46 may be used by the security vulnerability tool 36 to rescan only those network devices having security vulnerabilities. It should be appreciated that the vulnerability list 46 represents a subset of the global list 42, and may identify fewer network devices than the global list 42.

Before the vulnerability list 46 is used to rescan the network devices having security vulnerabilities, the tracking process 44 may be configured to update the dynamically assigned identifying information of the vulnerability list 46. For example, the vulnerability list 46 may identify a network device with a dynamically assigned IP address and a DNS name. The tracking process 44 may execute a DNS lookup, or any other known process of resolving a network address to a host name, to determine the currently assigned IP address associated with the DNS name. If the currently determined IP address differs from the IP address listed in the vulnerability list 46, the vulnerability list 46 is updated. While a specific example is given, it should be appreciated that the tracking process 44 may use any known static information identifying a network device to lookup any known dynamically assigned information associated with the network device.

The rescan of the vulnerability list 46 may be executed periodically to track remediation of security vulnerabilities, i.e., to determine if a security vulnerability has been remediated by determining if it is identified by security vulnerability tool 36. For example, the rescan may be initiated daily until no security vulnerabilities are identified, or at any other desired frequency. In addition, the tracking process 44 and/or the security vulnerability tool 36 may be configured to send a notification to each contact person associated with a network device of the vulnerability list 46. Further, it may be desirable to escalate a security vulnerability of a network device that is repeatedly identified by the vulnerability list 46. This escalation, for example, may include sending a notification to a supervisor of the computer network 12 if a security vulnerability is identified five times, or any other desired frequency, by the vulnerability list 46.

### INDUSTRIAL APPLICABILITY

Referring to FIG. 1, an exemplary embodiment of a system 10 includes a computer network 12 used to facilitate wired and/or wireless communication among a plurality of devices. The computer network 12 may include network devices 14, 16, and 18 at a first location 20 and network devices 24, 26, and 28 at a second location 30. Computer network 12 may also include a subnetwork database 32, a contact database 34, and any other addressable devices, systems, routers, gateways, subnetworks, or the like.

Each of the network devices 14, 16, 18, 24, 26, and 28 communicate over the computer network 12 and are, therefore, exposed to unauthorized access. Security vulnerability tools are commercially available and may assess the exposure of all of the devices, such as devices 14, 16, 18, 24, 26, and 28, connected to the computer network 12, and may provide an opportunity to address security vulnerabilities before they are exploited. However, because modern networks typically include a large number of devices, a scan of each network device by the security vulnerability software can take days, or even weeks, to complete. Therefore, tracking the remediation of security vulnerabilities identified by the security vulnerability software by rescanning each network device may not be timely or efficient.

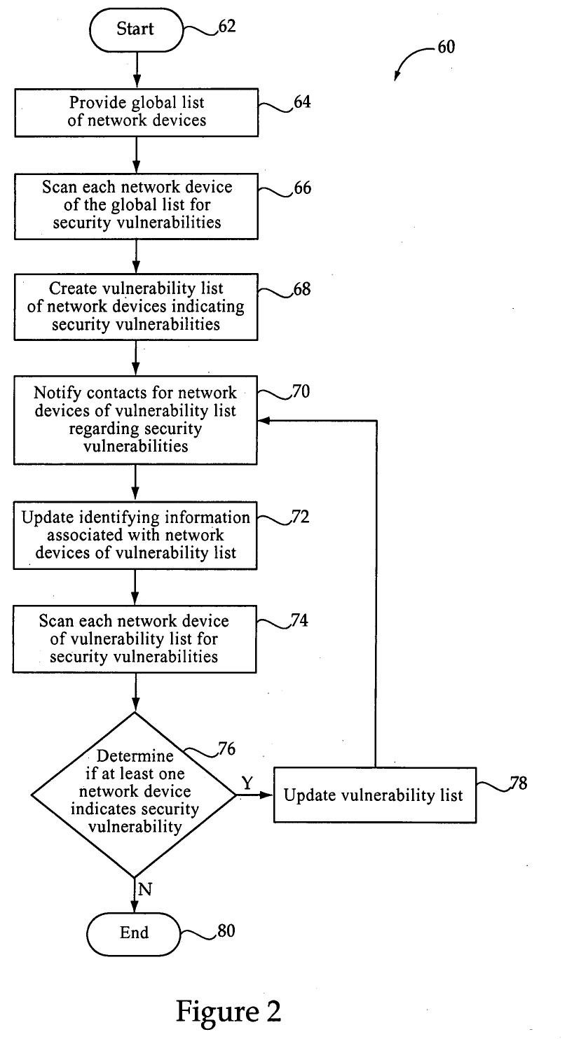

Utilizing the system and method of the present disclosure provides an efficient way of tracking remediation of identified vulnerabilities and, more specifically, a method of rescanning only those devices identified as having vulnerabilities. Turning to FIG. 2, there is shown a flow chart 60 representing an exemplary method of tracking remediation of security vulnerabilities. The method may be implemented in whole or, alternatively, in part by the security vulnerability tool 36. For example, the steps implementing the disclosed method may be stored in memory and executed by a processor of the security vulnerability tool 36. Alternatively, the method may be implemented using a network based application that can be stored on any machine or server and may be called up and manipulated from any location. In a further embodiment, the method may be implemented through a software agent stored on predetermined machines, servers, and workstations connected to the computer network 12.

The method begins at a START, Box 62. From Box 62, the method proceeds to Box 64, which includes the step of providing a global list 42 of network devices. The global list 42 may include identifying information, including dynamically assigned identifying information, regarding each network device 14, 16, 18, 24, 26, and 28 of the computer network 12. Alternatively, the global list 42 may include all of the ranges of network addresses that may be dynamically assigned to the network devices 14, 16, 18, 24, 26, and 28 of first location 20 and second location 30. For example, the global list 42 may be synchronized with the information stored in subnetwork database 32. The identifying information associated with each network device of the global list 42, therefore, may include the dynamically assigned network addresses, and any other identifying information. Specifically, the global list 42 may, at the least, include IP addresses 192.168.0.1-192.168.0.20 allocated to first location 20 and IP addresses 192.168.0.21-192.168.0.40 allocated to second location 30.

From Box 64, the method proceeds to Box 66. At Box 66, the security vulnerability tool 36 scans each network device or, more specifically, each IP address of the global list 42 for security vulnerabilities. The security vulnerability tool 36, by design, scans each of the network addresses of the global list 42 and identifies the network devices having at least one security vulnerability. The scan of the security vulnerability tool 36 may identify network devices having security vulnerabilities with identifying information. Such identifying information may include a network address, such as a dynamically assigned IP address. Additionally, the identifying information may include a Domain Name Server (DNS) name, if detected, and/or a Network Basic Input Output System (NetBIOS) host name, if detected, or any other directory names or host names that are associated with the network address. It should be appreciated that the security vulnerability tool 36 may be configured to return any desired information regarding network devices identified as having security vulnerabilities.

For example, security vulnerability tool 36 may scan IP addresses 192.168.0.1-192.168.0.40 and may identify IP addresses 192.168.0.12 and 192.168.0.39 as having security vulnerabilities. In addition, security vulnerability tool 36 may provide a DNS name, such as, for example, “DEVICE_16,” associated with the IP address 192.168.0.12. “DEVICE_16” may represent network device 16 or any other network device of location 20. Further, security vulnerability tool 36 may provide a DNS name, such as, for example, “DEVICE_28,” associated with the IP address 192.168.0.39. “DEVICE_28” may represent network device 28 or any other network device of location 30. Any additional identifying information may be provided, such as, for example, indications of the locations 20 and 30, to which network devices 16 and 28 belong, respectively.

At Box 68, a vulnerability list 46 of network devices having security vulnerabilities is created. Specifically, a tracking process 44 that may be executed on the same server, workstation, or other device as the security vulnerability tool 36 may create a vulnerability list 46 of the network devices having security vulnerabilities. The network devices of the vulnerability list may be identified with the identifying information returned by the network vulnerability tool 36. Further, the tracking process 44 may access the database 32 to determine the location associated with each of the network devices of the vulnerability list 46. Alternatively, the security vulnerability tool 36 may be configured to store and/or track this location information.

Returning to the example, the vulnerability list 46 may include the dynamically assigned IP addresses provided by the security vulnerability tool 36. Specifically, the vulnerability list 46 may include IP address 192.168.0.12 associated with network device 16 and location 20, and IP address 192.168.0.39 associated with network device 28 and location 30. This vulnerability list 46 may be used by the security vulnerability tool 36 to rescan only those network devices, specifically network devices 16 and 28, having security vulnerabilities. It should be appreciated that the vulnerability list 46 represents a subset of the global list 42, and may identify fewer network devices than the global list 42.

From Box 68, the method proceeds to Box 70, where contacts for network devices may be notified regarding security vulnerabilities. The tracking process 44 and/or the security vulnerability tool 36 and/or any other process or tool may be configured to send a notification to each contact person associated with a network device of the vulnerability list 46. According to the example, the contact database 34 may be queried to identify John Smith as the contact person for FIRST_LOCATION or, more specifically, first location 20. In addition, the contact database 34 may be used to determine that Mary Jones is the contact person for SECOND_LOCATION or, more specifically, second location 30. John Smith may then be notified via any known notification method, such as, for example, via an email notification, regarding the security vulnerability of network device 16. In addition, Mary Jones may be notified, such as via email, regarding the security vulnerability of network device 28. The contact email may be retrieved from still another database (not shown), such as a corporate directory. It may also be desirable to escalate a security vulnerability of a network device that is repeatedly identified by the vulnerability list 46.

At Box 72, the identifying information associated with each network device of the vulnerability list 46 is updated. Before the vulnerability list 46 is used to rescan the network devices having security vulnerabilities, the tracking process 44 may be configured to update the dynamically assigned identifying information of the vulnerability list 46. Turning again to the example, the vulnerability list 46 may identify IP address 192.168.0.12 and, at least, one piece of static identifying information, such as DNS name “DEVICE_16,” associating the dynamically assigned IP address to network device 16. Also, the vulnerability list 46 may identify IP address 192.168.0.39 and static identifying information, such as DNS name “DEVICE_28,” associating the dynamically assigned IP address to network device 28. The tracking process 44 may execute a DNS lookup, or any other known process of resolving a network address to a dynamic piece of identifying information, such as a host name, to determine the currently assigned IP address associated with each DNS name. It should be appreciated that, for example, “DEVICE_28” may currently be associated with any other IP address within the range of IP addresses 192.168.0.21-192.168.0.40. If the currently determined IP address differs from the IP address listed in the vulnerability list 46, the vulnerability list 46 will be updated.

The method determines, at Box 76, whether there is at least one network device identified by the vulnerability list 46. If at least one device is identified by the vulnerability list 46, the method proceeds to Box 78, where the vulnerability list 46 is updated. The method may continue with the steps of notifying contacts (Box 70), updating the identifying information (Box 72), scanning the network devices of the vulnerability list 46 (Box 74), and updating the vulnerability list 46 (Box 78) on a daily basis or at any other desired frequency. The method may also be repeated at the desired frequency until the method determines, at Box 76, that no network devices are identified by the vulnerability list 46. If there are not any network devices identified by the vulnerability list 46, the method then proceeds to an END, at Box 80.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A method of tracking remediation of security vulnerabilities, comprising:
providing a global list of network devices within a computer network, wherein each network device of the global list is identified with dynamically assigned identifying information;
scanning each network device of the global list for at least one security vulnerability;
creating a vulnerability list of network devices having the at least one security vulnerability, wherein the vulnerability list is a subset of the global list and contains fewer network devices than the global list, and wherein each network device of the vulnerability list is identified with dynamically assigned identifying information;
updating the dynamically assigned identifying information associated with the network devices of the vulnerability list; and
rescanning each network device of the updated vulnerability list to determine if the vulnerability has been remediated.

2. The method of claim 1, wherein the providing step includes identifying each network device with a dynamically assigned Internet Protocol address.

3. The method of claim 2, wherein the providing step further includes identifying each network device with a location associated with the dynamically assigned Internet Protocol address.

4. The method of claim 3, wherein the providing step further includes synchronizing the global list with a subnetwork database.

5. The method of claim 3, further including accessing a contact database to identify a designated contact person associated with each location.

6. The method of claim 5, further including sending a notification to each designated contact person associated with a network device of the vulnerability list.

7. The method of claim 1, wherein the creating step includes identifying each network device having a security vulnerability with a dynamically assigned Internet Protocol address and a host name.

8. The method of claim 7, wherein the updating step includes updating the Internet Protocol address associated with each host name.

9. The method of claim 1, further including updating the vulnerability list after the rescanning step to include network devices still having the at least one security vulnerability.

10. The method of claim 9, further including repeating the steps of updating the identifying information, rescanning each network device of the vulnerability list, and updating the vulnerability list until all security vulnerabilities have been remediated.

11. The method of claim 9, further including repeating the steps of updating the identifying information, rescanning each network device of the vulnerability list, and updating the vulnerability list on a daily basis.

12. A system for tracking remediation of security vulnerabilities, comprising:
a computer network including a plurality of devices;
a database containing a global list of the network devices, wherein each network device of the global list is identified with dynamically assigned identifying information;
a security vulnerability process configured to scan each network device of the global list for at least one security vulnerability;
a tracking process configured to create a vulnerability list of network devices having the at least one security vulnerability and update the dynamically assigned identifying information associated with the network devices of the vulnerability list;
wherein the vulnerability list is a subset of the global list and contains fewer network devices than the global list; and
wherein the security vulnerability process is further configured to rescan each network device of the updated vulnerability list to determine if the vulnerability has been remediated.

13. The system of claim 12, wherein each network device is identified with a dynamically assigned Internet Protocol address.

14. The system of claim 13, wherein each network device is further identified with a location associated with the dynamically assigned Internet Protocol address.

15. The system of claim 14, further including a subnetwork database, wherein the global list is synchronized with the subnetwork database.

16. The system of claim 14, further including a contact database associating a designated contact person with each location, wherein at least one of the security vulnerability process and the tracking process is further configured to send a notification to each designated contact person associated with a network device of the vulnerability list.

17. The system of claim 12, wherein the network devices of the vulnerability list are identified with a dynamically assigned Internet Protocol address and a host name.

18. The system of claim 17, wherein the tracking process is further configured to update the Internet Protocol address associated with each host name.

19. The system of claim 12, wherein the tracking process is further configured to update the vulnerability list after each network device of the vulnerability list are rescanned to include network devices still having the at least one security vulnerability.

20. The system of claim 19, wherein the tracking process is further configured to update the dynamically assigned identifying information, rescan each network device of the vulnerability list, and update the vulnerability list on a daily basis until all security vulnerabilities have been remediated.
